(19) United States
(12) Patent Application Publication
(10) Pub. No.: US 2004/0071617 A1
(43) Pub. Date: Apr. 15, 2004

(54) Fuel reformer

(76) Inventors: Scott Blanchet, Monroe, CT (US); Lawrence Novacco, Brookfield, CT (US)

Correspondence Address: ROBIN BLECKER & DALEY, 2ND FLOOR, 330 MADISON AVENUE, NEW YORK, NY, 10017, US

(21) Appl. No.: 10/269,481

(22) Filed: Oct. 11, 2002

(51) Int. Cl. B01J 8/02; B01F 5/00

(52) U.S. Cl. 422/220; 422/224

(57) ABSTRACT

A fuel reformer having an enclosure with an inlet port and an outlet port. A plate assembly for supporting catalyst is disposed in the enclosure. A compliant baffle is also disposed in the enclosure and cooperates with the plate assembly to establish a path for the flow of fuel gas through the reformer from the inlet port to the outlet port. The baffle and plate assembly also segment the enclosure into an inlet section communicating with the inlet port, an outlet section communicating with the outlet port and a turn section connecting the inlet and outlet sections. The baffle is further arranged to direct the flow of gas to a predetermined area of the turn section and the catalyst is disposed such that the reformer is devoid of catalyst in the inlet section to a point in the turn section and includes catalyst from that point in the turn section through the return section, the catalyst varying in amount in a predetermined manner in at least the return section.

### BACKGROUND OF THE INVENTION

This invention relates to fuel cells and, in particular, to a fuel reformer for use with such fuel cells.

A fuel cell is a device which directly converts chemical energy stored in hydrocarbon fuel into electrical energy by means of an electrochemical reaction. Generally, a fuel cell comprises an anode and a cathode separated by an electrolyte, which serves to conduct electrically charged ions. In order to produce a useful power level, a number of individual fuel cells are stacked in series with an electrically conductive separator plate between each cell.

In internally reforming fuel cells, a steam reforming catalyst is placed within the fuel cell stack to allow direct use of hydrocarbon fuels such as methane, coal gas, etc. without the need for expensive and complex reforming equipment. In a reforming reaction, fuel cell produced water and heat are used by the reforming reaction, and the fuel is internally reformed to produce hydrogen for fuel cell use. Thus, the endothermic reforming reaction can be used advantageously to help cool the fuel cell stack.

Two different types of direct fuel cell assemblies have been developed. Direct internal reforming is accomplished by placing the reforming catalyst within the active anode compartment. Although direct internal reforming provides the hydrogen produced directly to the anode, the major disadvantage of this technique is the exposure of the catalyst to the electrolyte of the fuel cell, which can significantly degrade its performance. For example, U.S. Pat. No. 5,660,941 provides a detailed structure in which direct internal reforming catalyst is placed in the anode flow field. The disadvantage of this technique is the deterioration of the catalyst because of electrolyte poisoning.

Several improvements to the aforementioned direct internal reforming technique have been proposed to avoid electrolyte contamination. U.S. Pat. No. 4,365,007 describes a direct internal reforming structure where the catalyst is partially isolated from the electrolyte by a porous barrier. This system relies on a pressure difference between the catalyst containing passage and the electrode containing passage to provide the reformed gas to the electrode and to prevent electrolyte vapor from reaching the catalyst. However, the disadvantage of this system is its high cost due to a complex current collector design and extra material for the porous member. Furthermore, uniform delivery of fuel gas to the active chamber through the porous sheet using differential pressure is difficult to achieve. U.S. Pat. No. 4,788,110 describes a direct internal reforming configuration where the anode current collector is formed to shield the catalyst from the electrolyte, thereby partially shielding the internal reformer. The drawback of this system is that most of the fuel gas would flow in the passages separated from the catalyst, greatly reducing the catalyst's effectiveness.

A second type of reforming is indirect internal reforming, which is accomplished by placing the reforming catalyst in an isolated chamber within the stack and routing the reformed gas from this chamber into the anode compartment of the fuel cell. The advantage of indirect internal reforming is that the reforming catalyst is protected from poisoning by the fuel cell's electrolyte. U.S. Pat. No. 4,182,795 describes an indirect internal reforming technique whereby fuel gas flow in the isolated passage is set independently of the flow in the active anode based on the desired overall quantity of cooling. This system, however, requires separate ducting systems for the two flow paths and external junctions and valves to deliver the reformed gas to the anode. U.S. Pat. No. 4,567,117 discusses an indirect internal reforming method employing a non-uniform catalyst application so as to promote uniform temperature distribution in the cell. This system suffers from the same disadvantages as the system described in the '795 patent, requiring separate ducting systems for the two flow paths and external junctions and valves.

Other indirect internal reforming systems disclosed in the prior art suffer from certain limitations and cost disadvantages. U.S. Pat. No. 5,175,062 discloses an indirect reformer plate that is integrated into an adjacent fuel cell housing with a fuel feed port at its corner. Due to the required size of the fuel feed tube, this system results in a very high fuel gas pressure drop and an expensive design. U.S. Pat. No. 5,348,814 shows an indirect internal reformer plate designed to provide reactive cooling to an internally manifolded fuel cell stack. However, the cost of such a stack is very high because of the complexity of the bipolar plate design.

The present state of the art utilizes a hybrid assembly of a fuel cell with both direct and indirect internal reforming. U.S. Pat. No. 4,877,693 describes a fuel cell system employing both indirect and direct internal reforming with the delivering of the reformed gas from the indirect reforming chamber to the anode flow field. In another hybrid assembly, as described in U.S. Pat. No. 6,200,696, the indirect internal reformer is designed with a substantially U-shaped flow geometry, which allows the inlet fuel feed tubes to also be contained within the fuel-turn manifold thereby mitigating the risk of system fuel leaks. With this configuration non-optimized flow field and the catalyst distribution within the plate result in large temperature gradients near the edge of the fuel cell plate. In addition, manufacturing the reformer plate makes it difficult to form a gas seal between the various sections of the reformer bed, resulting in unreformed fuel gas leaking through the bed. This, in turn, results in non-uniform reforming and higher temperature gradients than could be achieved.

It is therefore an object of the present invention to provide an improved fuel reformer having a more optimum flow field and catalyst distribution, thereby reducing non-uniformity in reforming and temperature gradients.

It is a further object of the invention to provide a multi-component fuel reformer that inhibits fuel gas leaks from the reformer prior to exposure to the catalyst.

### SUMMARY OF THE INVENTION

In accordance with the principles of the invention, the above and other objectives are realized in a reformer including an enclosure having an inlet port and an outlet port, a plate assembly for supporting catalyst disposed within the enclosure, and a compliant baffle cooperating with said plate assembly for establishing a path for the flow of fuel gas through the reformer from said inlet port to the outlet port.

The baffle and plate assembly also segment the enclosure into an inlet section communicating with the inlet port, an outlet section communicating with the outlet port and a turn section connecting the inlet and outlet sections. In further aspects of the invention, the baffle is further arranged to direct the flow of gas to a predetermined area of the turn section and the catalyst is disposed such that the reformer is devoid of catalyst in the inlet section to a point in the turn section and includes catalyst from that point in the turn section through the return section, the catalyst varying in amount in a predetermined manner in at least the return section.

With this configuration for the reformer, the compliant baffle allows for improved sealing of the reformer components so as to better prevent the escape of gases from the reformer. Additionally, the use of the baffle to direct the flow of gases in the turn section and the catalyst distribution enable the reformer to promote improved temperature distribution and reduce temperature gradients. Also, the catalyst distribution can be tailored to aid in providing a desired gas composition

### BRIEF DESCRIPTION OF THE DRAWINGS

The above and other features and aspects of the present invention will become more apparent upon reading the following detail description in conjunction with the accompanying drawings in which:

FIG. 1 shows a plan view of a fuel reformer in accordance with the principles of the present invention;

FIG. 2 shows an illustrative pattern for loading reforming catalyst into the fuel reformer of FIG. 1;

FIG. 3 shows a cross-flow fuel cell stack employing the fuel reformer of FIG. 1;

FIG. 4 shows schematically the cross-section of the cross-flow fuel cell stack of FIG. 3;

FIG. 5 shows measured flow distribution data for the fuel cell stack of FIG. 4 and for a cross-flow fuel cell stack employing a conventional reformer;

FIG. 6 shows measured temperature distribution data for a cross-flow fuel cell stack using a conventional reformer; and

FIG. 7 shows measured temperature distribution data for the cross-flow fuel cell stack of FIG. 4.

### DETAILED DESCRIPTION

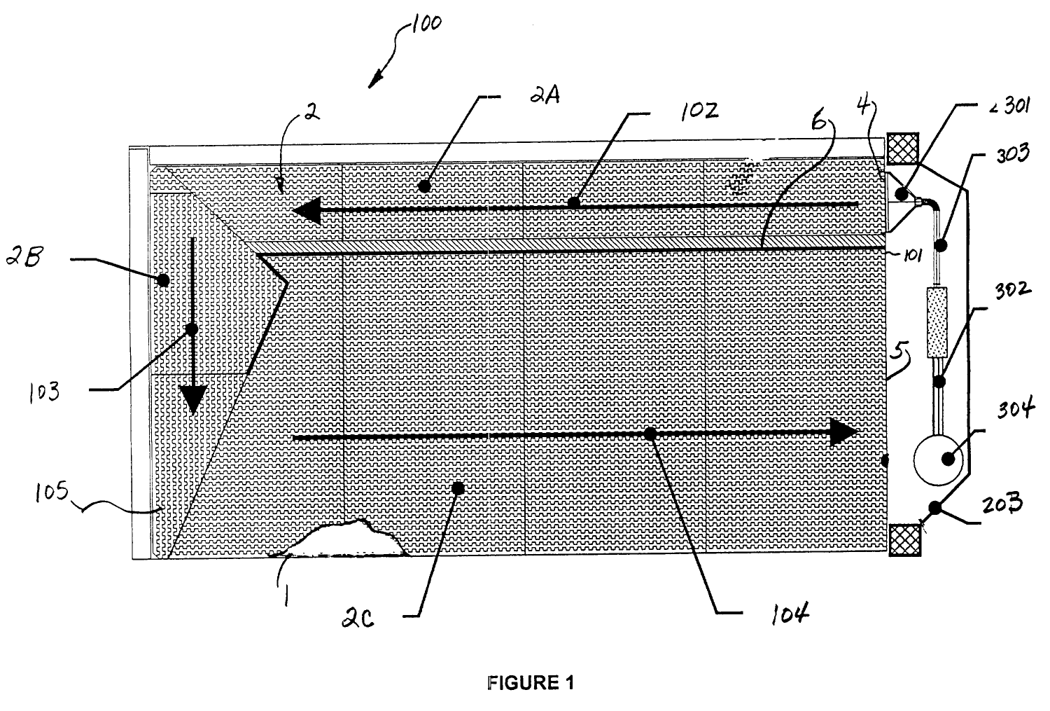

FIG. 1 shows a plan view of a reformer 100 in accordance with the principles of the present invention. The reformer 100 includes an outer housing or foil 1 which houses or envelops a plate assembly 2 comprising plates of corrugated sheet metal 2A-2C. Inlet and outlet ports 4 and 5 of the reformer 100 are located on the same face 101 of the reformer. These ports are adjacent to and isolated from one another.

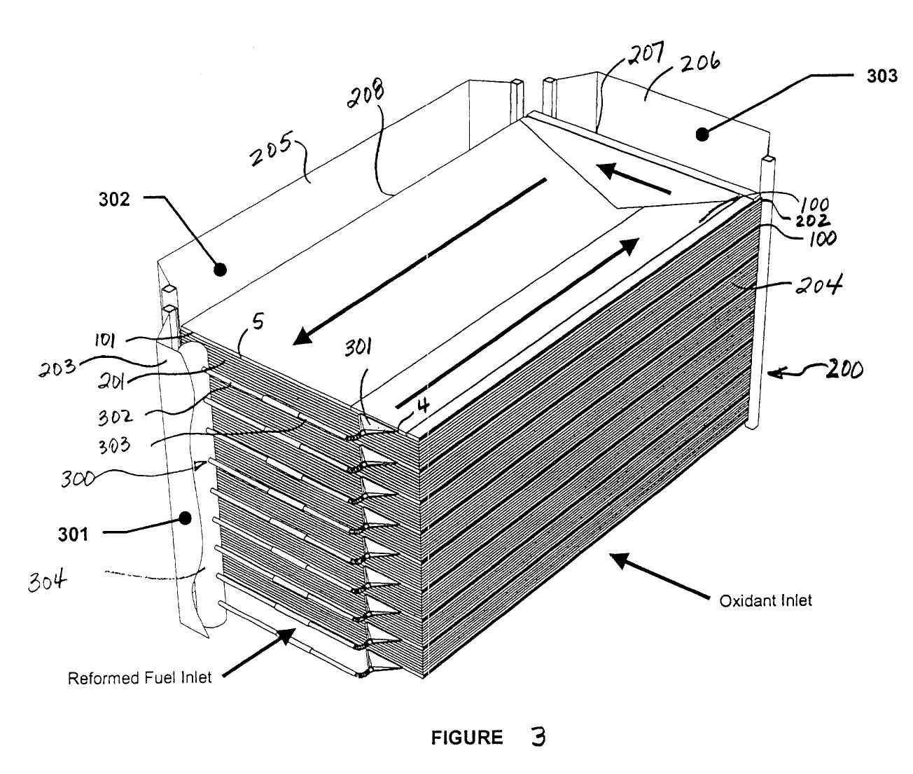

Referring to FIG. 3, a plurality of the reformers 100 are arranged in a fuel cell stack 200 in interleaved fashion with groups of fuel cells 202 of the stack. The face 101 of each reformer 100 forms part of the face 201 of the fuel cell stack 200, the latter face being the face of the stack having the anode chamber inlets of the fuel cells 202.

A reformer fuel delivery system 300 supplies fuel to the reformers 100 and comprises for each reformer a plenum 301, attached to the inlet port 4 of the respective reformer, and feed tube sections 302 and 303. Fuel gas is supplied from a common fuel inlet header pipe 304 to the feed tube sections 302 and 303 of each reformer 100 and from the feed tube sections to the associated plenum 301. Fuel gas is then delivered from each plenum 301 through the inlet 4 to the respective reformer 100.

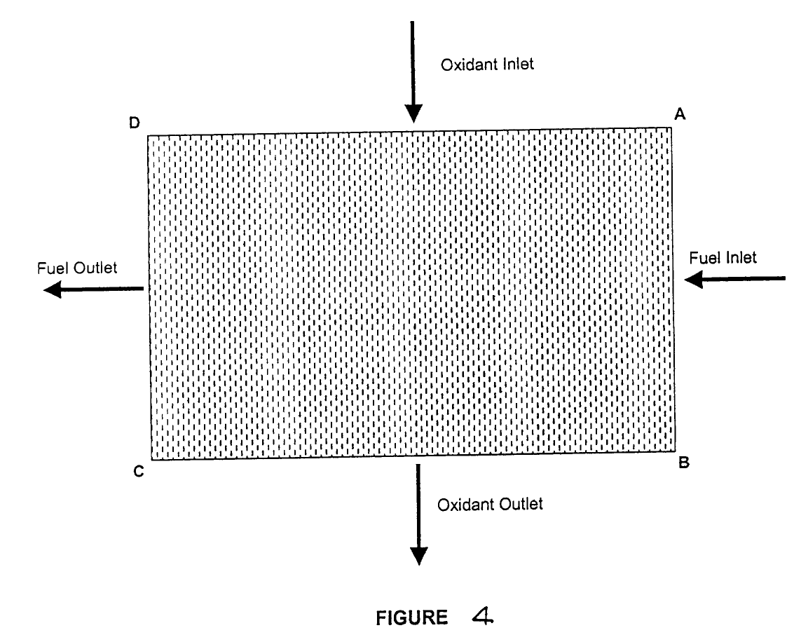

The reformer fuel delivery system 300 as well as the inlet ports 4 and the outlet ports 5 of the reformers 100 are encapsulated by a fuel-turn manifold 203. The manifold 203 covers the face 201 of the stack and acts to prevent the loss of fuel due to any small leaks in the header pipe 304, feed tubes 302 and 303, or plenums 301. As also shown in FIG. 4, fuel cell stack 200 includes further manifolds 205 and 206 for receiving exhausted oxidant and fuel gases, respectively, passing from the stack via the fuel gas outlet face 207 and the oxidant gas outlet face 208. The gases thus pass through the fuel cells 202 in cross-flow to each other and the cells 202 and the stack 200 are, therefore, referred as cross-flow cells and a cross-flow stack.

Returning now again to FIG. 1, the corrugated sheet metal plates 2A-2C of the reformer 100 are arranged in such a way as to provide a generally U-shaped flow path for the fuel gas. As shown, the plate 2B is triangular in shape, while the plates 2A and 2C are substantially rectangular in shape, with the plate 2A being narrower than the plate 2C. The far end of the plate 2A is angled to abut and follow a first inclined surface of the plate 2B at the interface of the plates 2A and 2B. The far end of the plate 2C is also similarly angled to abut and follow the remaining portion of this inclined first surface of the plate 2B at the interface of the plates 2B and 2C. The far end of the plate 2C is then further angled to abut and follow a second inclined surface of the plate 2B, this second inclined surface being situated adjacent the first inclined surface.

With this configuration, the flow channels formed by the corrugated sheet metal plates 2A-2C allow the gas to flow from the inlet port 4 along the length of the plate 2A (the “inlet section” 102 of the reformer 100). The gas then turns 90 degrees at the interface between the plates 2A and 2B, thereafter flowing along the length of the plate 2B (the “turn section” 103 of the reformer 100). The gas at the interface of the plates 2B and 2C again turns 90 degrees and flows along the length of the plate 2C (the “return section” 104 of the reformer 100) in a direction counter to the inlet section.

To isolate the inlet section 102 of the reformer 100 from the return section 104 and to provide further direction to the gas in the turn section 103, the reformer 100 is further provided with a compliant baffle 6. As shown, the baffle 6 is situated along substantially the entire interface of the plates 2A and 2C and along a part of the interface of the plates 2B and 2C, i.e., along the interface part containing the first inclined surface of the plate 2B and a segment of the second inclined surface extending from the first inclined surface. The baffle 6 thus prevents the fuel gas from flowing from the inlet section 102 directly into the return section 104 of the reformer, and instead directs the flow of gas through the turn section 103. The gas, therefore, flows in the aforementioned U-shaped path from the inlet to the outlet port of the reformer.

In addition, the baffle 6 at the interface of the plates 2B and 2C urges the fuel gas in the turn section 103 toward the corner 105 of the reformer. This results in a desired greater cooling of this corner, as will be discussed more fully below.

Because the gas flow in the reformer 100 is substantially pressure driven, it is important that the baffle 6 be sufficiently compliant to fill any gaps between the abutting plate surfaces at the interfaces of the plates 2A-2C and between the baffle and the reformer housing 1. To this end, the baffle 6 may be made from ceramic paper, rope or yarn, or any other soft material suitable for a high-temperature reducing atmosphere. For example, a suitable ceramic paper material may include Kaowool® Blanket manufactured by Thermal Ceramics Company, which is a flexible compliant Alumina/Silica blanket and which can be cut into strips appropriate for sealing the gaps within the reformer plate bed.

As discussed above, with this configuration for the reformer 100, fuel gas entering the inlet port 4 through the plenum 301 flows along the inlet section 102 without leaking into the return section 104. The flow of the fuel gas is then directed by the baffle 6 and the plates 2A and 2B to turn 90 degrees and to flow along the turn section 103 in the direction of the corner 105 of the reformer. The fuel gas then again turns 90 degrees and flows along the return section 104, exiting the reformer 100 through the outlet port 5. From there it enters the fuel-turn manifold 203 covering the face 201 of the fuel cell stack 200. As seen in FIG. 3, the manifold 203, in turn, acts to redirect the reformed fuel gas from the reformer into the anode chambers of the fuel cells 202 of the stack 200.

As the fuel gas passes through the reformer 100 in the U-shaped path, it undergoes an endothermic reforming reaction. To facilitate this reforming reaction, and thus the cooling effect, catalyst is strategically distributed within the reformer so as to provide uniform reforming of the fuel gas and to lower temperature gradients within the reformer. The distributed catalyst may be in the form of catalyst pellets, tablets or any other form.

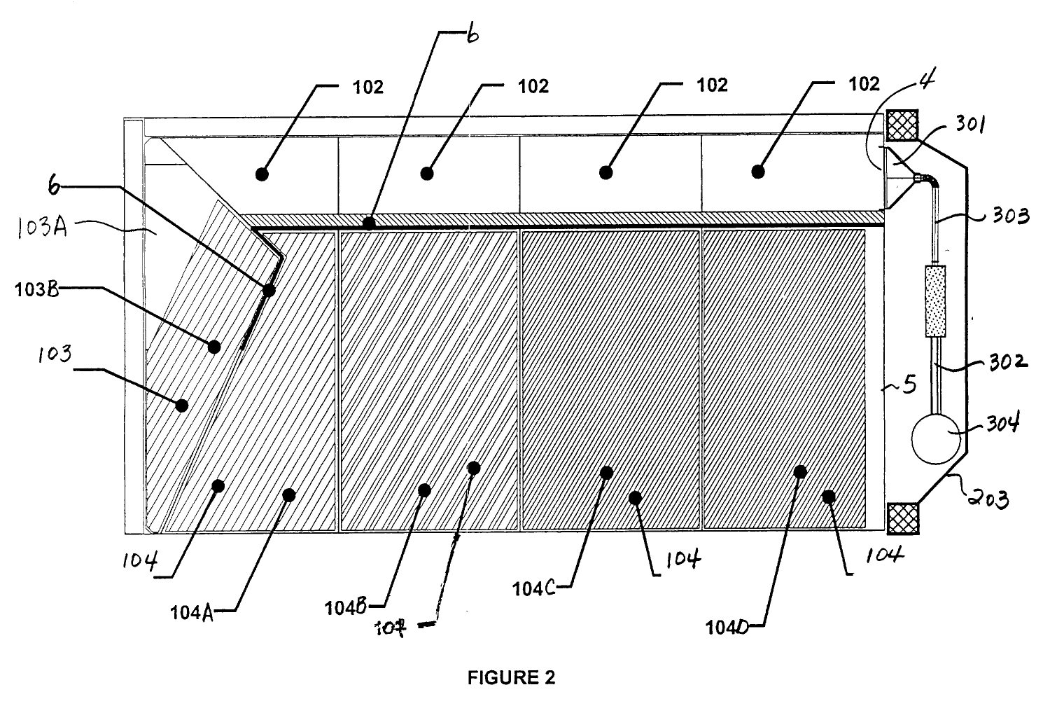

FIG. 2 shows an illustrative pattern for loading the reforming catalyst into the reformer 100. In this pattern, the amount of catalyst is the increased in a predetermined fashion in the direction of the fuel gas flow. More particularly, in accord with the invention, catalyst loading of the reformer 100 is such as to provide a distribution of fuel gas reforming which when the reformer is used in a fuel cell stack, as in FIG. 4, the reformer cools the hottest areas of the stack and improves temperature distribution. This cooling of the hottest areas of the stack and improved temperature distribution is also aided by the baffle 6 which directs the flow of gas to particular areas of the reformer along the U-shaped path.

To this end and as shown in FIG. 2, for the reformer 100 as used in the cross-flow stack 200, there is no catalyst in the inlet section 102. With no catalyst in this section, excessive cooling of the stack 200 along the oxidant inlet face 204 of the stack, which face is adjacent the inlet sections 102 of the reformers 100, is avoided. Because the oxidant that enters the stack 200 in the area of each of the inlet ports 4 of the reformers 100 has not yet undergone an electrochemical reaction, the inlet sections 102 of the reformers can now act as a heat exchangers to warm the incoming, unreformed fuel gas with heat from the oxidant inlet gas.

As also shown in FIG. 2, catalyst distribution begins in a part of the turn section 103 and along the entire return section 104 of the reformer 100. These are the areas of the reformer 100 which are located in areas of the stack 200 where the temperature of the stack is higher due to the cross flow configuration of the stack. Moreover, because the catalyst in the turn section 103 and the return section 104 is very active, a gradual increase in the loading along the flow path is desired. Such gradual loading operates to prevent large temperature gradients and cold spots due to excessive, localized endothermic reactions.

More particularly, in the turn section 103 of the reformer 100, there is no catalyst in the corner section 103A adjacent the inlet section 102. Catalyst loading begins in the section 103B at a first loading density, which is set relatively low, to prevent overcooling of the reformer in this section. Loading of the same density then continues into a first portion 104A of the return section 104. A second section 104B of the return section is then loaded with a second catalyst density higher than the first density, and third and fourth sections 104C and 104D are, in turn, loaded with third and fourth catalyst densities, the third density being higher than second density and the fourth density being equal to the third density. This variation of catalyst density along the turn and return sections distributes the amount of gas undergoing endothermic reaction, and thus the heat absorption, so as to bring the reformer 100 to a more uniform temperature.

One illustrative distribution of the catalyst in the reformer 100 would be to use one catalyst pellet every four corrugation rows in the sections 103A and 104A, subsequently increasing the catalyst loading to one catalyst pellet every two rows in the section 104B, then three catalyst pellets every four rows in the section 104C, and finally one catalyst per row (fully loaded) in the final section 104B. Hence, as unreformed gas flows through the turn section and encounters the catalyst distributed in its path, the gas begins to undergo a reforming reaction, absorbing heat and thus cooling the reformer plate and surrounding fuel cell stack components.

FIG. 4 shows a schematic of the cross-section of the of the cross-flow fuel cell stack 200 of FIG. 3, where, since each of the fuel cells 203 of the stack is of a rectangular configuration, the stack cross-section is also of rectangular configuration. The face 201 is the fuel inlet face and the face 204 the oxidant inlet face of the stack. The faces 207 and 208 are the fuel and oxidant exhaust gas faces of the stack.

In FIG. 4, the corners of the fuel cell stack 200 are labeled A through D. The corner of the fuel cell stack that is adjacent the fuel gas inlet and the oxidant gas inlet faces is labeled A. The corner of the stack which is adjacent the fuel gas inlet face and the oxidant gas outlet face is labeled B. The corner of the fuel cell stack which is adjacent the fuel gas outlet face and the oxidant gas outlet face is labeled C. Finally, the corner of the fuel cell stack which is adjacent the oxidant gas inlet face and the fuel gas outlet face is labeled D.

In general, the temperature distribution for the fuel cell 200 is coldest at corner A and hottest at corner C. Therefore, it is important to counteract this natural temperature distribution and to provide more cooling near corner C, thereby reducing the maximum temperature experienced by the stack near this corner. As described above, enhanced cooling of corner C of the stack 200 is accomplished by using compliant baffle 6 in the reformers 100 to direct the fuel gas flow toward the corner 105 of the reformers, and thus the corner C of stack, and by strategically placing the catalyst in the reformers at this corner. Both of these effects enhance the endothermic reforming reaction at this location, thereby providing greater cooling.

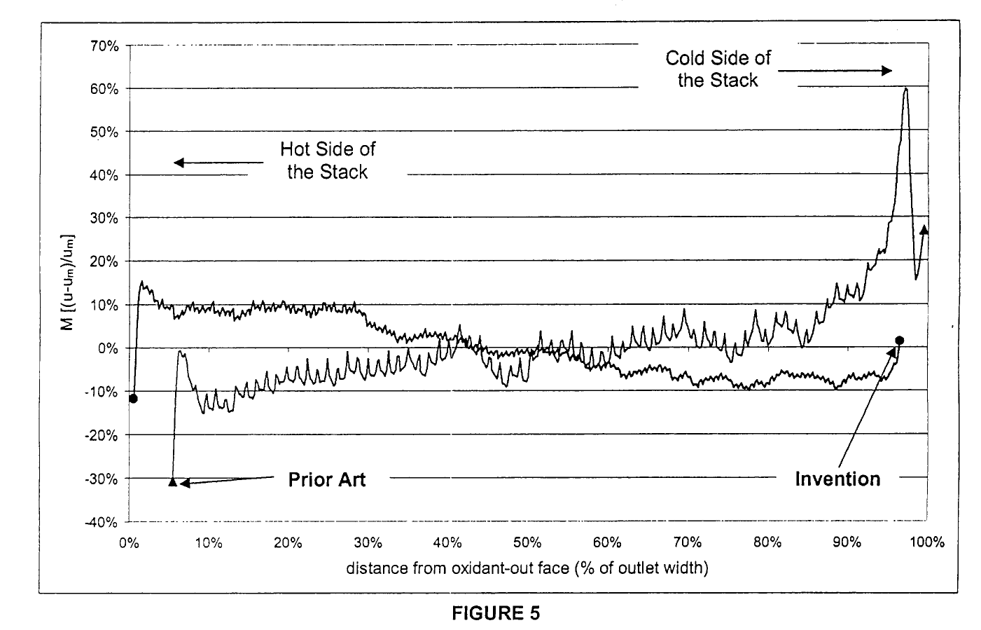

FIG. 5 is a graph showing measured flow distribution data for the stack 200 using the reformer 100 of the invention (this graph is labeled “Invention”) and for a stack incorporating a conventional reformer (this graph is labeled “Prior Art”). As seen from this data, there is an increased fuel flow delivered to the hot side of the stack 200 of the invention, as compared to the stack using the conventional reformer.

More particularly, in FIG. 5, the X-axis represents the distance away from the oxidant gas outlet face 208 of the fuel cell stack 200. The hot side of the fuel cell stack is located at the 0 of the X-axis and the distance away from the hot side increases in increments of the percentage of the outlet width as the X-axis values increase. The Y-axis represents the non-uniformity of the fuel gas flow in the stack. On the Y-axis, 0% is the average gas flow, the positive percentage values correspond to higher than average gas flow and the negative percentage values correspond to lower than average gas flow. Hence, as the Y value increases, the fuel gas flow also increases. The two graphs thus represent the fuel gas flow measurements at various distances from the hot side of the their respective stacks.

As shown in FIG. 5, the fuel gas flow in the reformer near the edge of the stack's hot side is greater for the stack 200 as compared to the stack using the conventional reformer. Hence, with gas flow being directed by the baffle 6 in the reformers 100 of the invention, the reformers can cause increased gas flow toward the side or edge (at 0% X distance) of the stack, thereby providing increased cooling.

The Prior Art graph in FIG. 5, representing the fuel gas flow for the fuel cell stack having the conventional reformer, on the other hand, shows that the gas flow in locations approaching the cold side of the stack is much greater than in areas close to the hot side of the stack. As a result, in this stack, a lesser amount of fuel gas is reformed near the hot side of the stack, resulting in high temperature gradients.

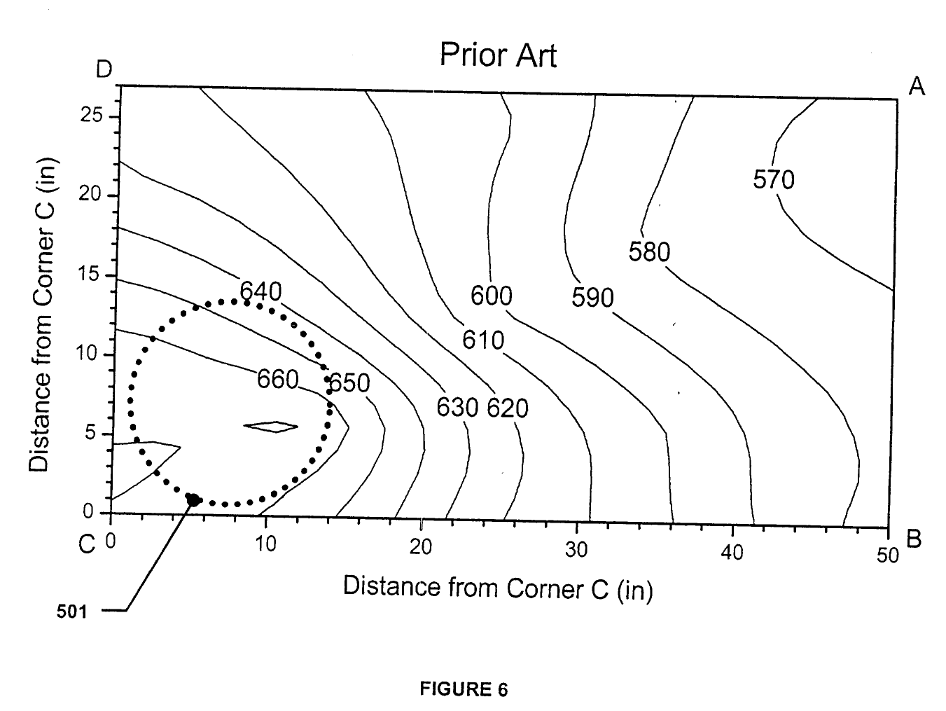

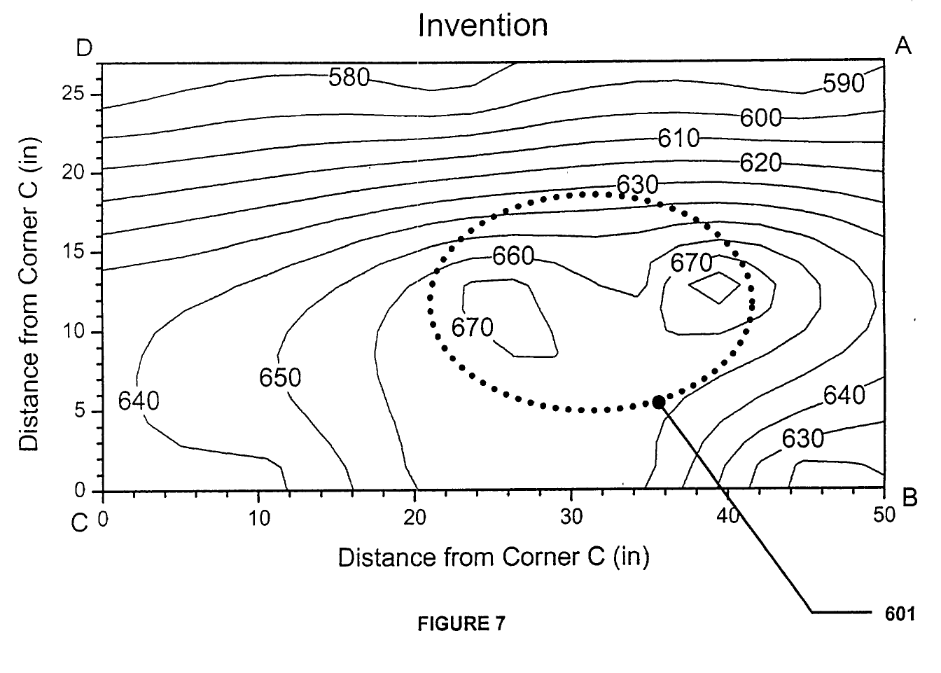

As above-stated, in the stack 200 incorporating the reformer of the invention, because more fuel gas is delivered to the hot side of the stack, more of the gas is reformed in that location, cooling the stack in the hottest areas. This effect is further demonstrated in FIGS. 6 and 7.

FIG. 6 shows a graph of measured temperature distribution data for a prior art stack incorporating a conventional reformer illustrating the position of the hot point 501 near corner C of the stack. More particularly, in FIG. 6, the X and Y axes represent the distances in the stack from corner C of the stack, increasing in the direction away from corner C. The curves across the stack represent isotherms of temperature in the stack.

For example, the temperature near corner A of the stack is the lowest, at 570 degrees Celsius. As shown in the FIG. 6, the measured temperature near corner C of the stack is the highest, nearly 100 degrees higher than in corner A. Thus the hot point 501 is located near corner C, resulting in high temperature gradients in the stack using the conventional reformer. Such high temperature gradients near corners and edges of the stack may cause a breech of the gas seal between adjacent cells of the stack at the peripheries of the cells. FIG. 7 shows a graph of measured temperature distribution data for the stack 200 using the reformer of the invention. In this case, the hot point 601 is shifted from corner C of the stack to the center of the stack. As displayed in FIG. 7, the temperature in the fuel cell stack is lowest along the oxidant inlet face bordered by the corners AD of the stack and highest in the center of the stack. This shift of the hot point results from the ability of the reformers 100 of the invention used in the stack 200 to direct more fuel gas toward corner C of the stack for reforming and from strategic placement of the catalyst within the reformers, thereby achieving a greater cooling effect in the area near the corner C. The shift of the hot spot from corner C to the center of the stack also acts to prevent gas leaks at the edges of the reformer, because the temperature is now lowered, preventing the breach of the gas seal.

The distribution of the catalyst in the reformers 100 of the invention has been discussed above in terms of realizing an improvement in the temperature distribution in the fuel cell stack 200. However, it is also within the contemplation of the invention to additionally select the catalyst distribution to achieve a desired fuel gas composition leaving the reformes for entry into the anode chambers of the fuel cells 202 of the stack 200.

In all cases it is understood that the above-described arrangements are merely illustrative of the many possible specific embodiments which represent applications of the present invention. Numerous and varied other arrangements can be readily devised in accordance with the principles of the present invention without departing from the spirit and the scope of the invention. More particularly, the extending of the baffle 6 and the type of catalyst distribution, as shown in FIGS. 1 and 2, to promote desired heat distribution in the reformer can be used as well with conventional baffles made of stiff material. Additionally, the baffle 6 of FIGS. 1 and 2 can be used with conventional catalyst distributions, and the catalyst distribution of FIGS. 1 and 2 can be used with conventional baffles.

What is claimed is:

1. A fuel reformer comprising:
an enclosure having an inlet port and an outlet port; a plate assembly for supporting catalyst disposed within said enclosure, and a compliant baffle cooperating with said plate assembly for establishing a path for the flow of fuel gas through said reformer from said inlet port to said outlet port.

2. A fuel reformer in accordance with claim 1, wherein said plate assembly includes a plurality of plates and said compliant baffle is positioned between at least first and second plates of said plurality of plates to form a plurality sections in said reformer.

3. A fuel reformer in accordance with claim 2, wherein said plurality of sections include an inlet section communicating with said inlet port and an outlet section communicating with said outlet port.

4. A fuel reformer in accordance with claim 3, wherein said inlet port and said outlet port are located on the same first face of said enclosure, said first and second plates extend from said first face of said enclosure in adjacent relationship in said enclosure to short of the opposite second face of said enclosure, and said compliant baffle extends between abutting surfaces of said first and second plates, said inlet section being along the length of said first plate and said outlet section being along the length of said second plate.

5. A fuel reformer in accordance with claim 4, wherein said plurality of sections include a turn section from the ends of said first and second plates facing said second face of said enclosure to said second face of said enclosure, said plurality of plates include a third plate in said turn section which abuts said ends of said first and second plates, and said compliant baffle extends between the abutting surfaces of said first and third plates and a portion of the abutting surfaces of said second and third plates.

6. A fuel reformer in accordance with claim 5, wherein:
said first and second plates are substantially rectangular and said third plate is triangular, and a first inclined surface of said third plate abuts with an inclined surface of the first plate and a first inclined surface of said second plate, and a second inclined surface of said third plate adjacent to the first inclined surface of said third plate abuts with a second inclined surface of the second plate, said baffle extending between the abutting surfaces of said second and third plates beginning at said first inclined surface of said second plate and ending short of the end of said second inclined surface of said second plate.

7. A fuel reformer in accordance with claim 6, wherein said plate member supports catalyst such that said inlet section is devoid of catalyst and said turn section and said return section contain catalyst, said catalyst in said turn and return sections varying in a predetermined manner along the flow path.

8. A fuel reformer in accordance with claim 7, wherein:
the entry of said turn section is devoid of catalyst.

9. A fuel reformer in accordance with claim 1, wherein said path includes an inlet section communicating with said inlet port, a return section communicating with said outlet port and a turn section connecting said inlet section and said return section.

10. A fuel reformer in accordance with claim 9, wherein said fuel inlet port and said fuel outlet port are located on the same face of said enclosure and wherein said compliant baffle extends along the length of said enclosure so as to partially separate said inlet section from said return section and along the width of said enclosure so as to partially separate said turn section from said return section.

11. A fuel reformer in accordance with claim 10, wherein a portion of said compliant baffle at the interface of said turn section and said return section is first angled away from the corner of the turn section at the interface of the turn section and the return section and is then angled in the direction of the corner.

12. A fuel reformer in accordance with claim 9, wherein said compliant baffle comprises two segments, wherein a first segment separates said inlet section from said return section and a second segment partially separates said turn section from said return section.

13. A fuel reformer in accordance with claim 12, wherein said second segment of the compliant baffle extends from said first segment in the direction angled away from the corner of the turn section at the interface of the turn section and the return section and is then angled in the direction of the corner.

14. A fuel reformer in accordance with claim 1, wherein said compliant baffle seals said path for gas flow so as to prevent gas leaks along said path.

15. A fuel reformer in accordance with claim 1, wherein said compliant baffle is made from soft material suitable for a high-temperature reducing atmosphere.

16. A fuel reformer in accordance with claim 15, wherein said compliant baffle is made from one or more of ceramic paper material, rope, yarn and material compatible with a high-temperature reducing atmosphere.

17. A fuel reformer in accordance with claim 1, wherein said compliant baffle is configured to direct the flow of gas to a predetermined region of said flow path.

18. A fuel reformer in accordance with claim 1, wherein said predetermined region is in a corner of said reformer at the end of a turn section of said path.

19. A fuel reformer in accordance with claim 1, wherein said plate assembly comprises one or more corrugated plates.

20. A fuel reformer in accordance with claim 1, wherein said catalyst varies in amount along said path.

21. A fuel reformer in accordance with claim 1, wherein said reformer is devoid of catalyst through an inlet section of said reformer path to a point in a turn section of said reformer and then varies in a predetermined manner in the remainder of said turn section and in a return section of said reformer.

22. A fuel reformer comprising:
an enclosure having an inlet port and an outlet port; a plate assembly for supporting catalyst disposed within said enclosure; and a compliant baffle cooperating with said plate assembly for establishing a path for the flow of fuel gas through said reformer from said inlet port to said outlet port and for segmenting said enclosure into an inlet section communicating with said inlet port, an outlet section communicating with said outlet port, and a turn section connecting said inlet section to said outlet section, said baffle extending into said turn section to enhance the amount of gas flow to a preselected area of said turn section.

23. A fuel reformer in accordance with claim 22, wherein said plate member is corrugated.

24. A fuel reformer in accordance with claim 22, wherein said preselected area is an area at the corner of the interface of said turn section and said return section.

25. A fuel reformer in accordance with claim 24, wherein said baffle extends into said turn section first angled away from said corner and then angled toward said corner.

26. A fuel reformer in accordance with claim 25, wherein:
said plate assembly includes a plurality of plates and said baffle is positioned between at least first and second plates of said plurality of plates to form a plurality sections in said reformer;
said plurality of sections include an inlet section communicating with said inlet port and an outlet section communicating with said outlet port;
said inlet port and said outlet port are located on the same first face of said enclosure, said first and second plates extend from said first face of said enclosure in adjacent relationship in said enclosure to short of the opposite second face of said enclosure, and said baffle extends between abutting surfaces of said first and second plates, said inlet section being along the length of said first plate and said outlet section being along the length of said second plate;
said plurality of sections include a turn section from the ends of said first and second plates facing said second face of said enclosure to said second face of said enclosure, said plurality of plates include a third plate in said turn section which abuts said ends of said first and second plates, and said baffle extends between the abutting surfaces of said first and third plates and a portion of the abutting surfaces of said second and third plates; and
said first and second plates are substantially rectangular and said third plate is triangular, and a first inclined surface of said third plate abuts with an inclined surface of the first plate and a first inclined surface of said second plate, and a second inclined surface of said third plate adjacent the first inclined surface of said third plate abuts with a second inclined surface of the second plate, said baffle extending between the abutting surfaces of said second and third plates beginning at said first inclined surface of said second plate and ending short of the end of said second inclined surface of said second plate.

27. A fuel reformer in accordance with claim 22, wherein said reformer is devoid of catalyst through said inlet section to a point in said turn section and includes catalyst in the remainder of said turn section and in said return section.

28. A fuel reformer in accordance with claim 27, wherein said catalyst varies in amount in a predetermined manner in said return section.

29. A fuel reformer comprising:
an enclosure having an inlet port and an outlet port; a plate assembly for supporting catalyst disposed within said enclosure, said plate assembly establishing a path for the flow of fuel gas through said reformer from said inlet port to said outlet port and segmenting said enclosure into an inlet section communicating with said inlet port, an outlet section communicating with said outlet port, and a turn section connecting said inlet section to said outlet section, said reformer being devoid of catalyst in said inlet section and to a point in said turn section and including catalyst from said point in said return section through said return section, said catalyst varying in amount in a predetermined manner in at least said return section.

30. A fuel reformer in accordance with claim 29, wherein said plate assembly comprises corrugated plates.

31. A fuel reformer in accordance with claim 29, further comprising a compliant baffle for aiding said plate assembly in establishing said flow path.

32. A fuel reformer in accordance with claim 29, wherein said inlet port and said outlet port are located on the same face of said enclosure.

33. A fuel reformer in accordance with claim 32, wherein said path is U-shaped.
